(19) United States
(12) Patent Application Publication
(10) Pub. No.: US 2006/0132321 A1
(43) Pub. Date: Jun. 22, 2006

(54) Universal equipment process monitor

(76) Inventors: Mark Edwin Thouin, Murfreesboro, TN (US); Jeremy Edwin Thouin, Murfreesboro, TN (US)

Correspondence Address: W. EDWARD RAMAGE, COMMERCE CENTER SUITE 1000, 211 COMMERCE ST, NASHVILLE, TN, 37201, US

(21) Appl. No.: 11/292,874

(22) Filed: Dec. 2, 2005

Related U.S. Application Data
(60) Provisional application No. 60/632,838, filed on Dec. 3, 2004.

(51) Int. Cl. G08B 21/00; G05B 23/02; G01M 19/00; G08B 19/00; G08C 19/16

(52) U.S. Cl. 340/679; 340/521; 340/870.01; 340/3.51; 702/124

(57) ABSTRACT

A system and apparatus for continuously receiving and monitoring input and other data from an industrial machine or piece of equipment. A monitoring unit is removably attached to the machine, or plugged into a junction box attached to the machine. The monitoring unit continuously tests the validity of input data streams from a variety of sensors on the machine, and provides warnings through audible or visual signals, or by email. The monitoring unit can shut down machine operations if a variety of fault conditions are detected. Several monitoring units on a plurality of machines can be connected to a computer or network. An operator or other personnel can send and receive information to and from the monitoring units. Information can be stored permanently in a database or similar data storage means, and used to produce a variety of useful reports and analyses.

This application claims priority to Provisional Patent Application No. 60/632,838, filed Dec. 3, 2004, by Mark Thouin, and is entitled in whole or in part to that filing date for priority. The specification of Provisional Patent Application No. 60/632,838 is incorporated herein in its entirety by reference.

### FIELD OF INVENTION

This invention relates generally to an apparatus and system for monitoring a process. More particularly, the present invention relates to an apparatus and system for monitoring a variety of input signals from various manufacturing equipment and machinery on a continuous basis, and providing output signals or warnings to the operator and monitoring programs or systems.

### BACKGROUND OF INVENTION

At present, many systems are known for the continuous production, handling, and processing of various products. Such systems may be automated in whole or in part, and typically consist of a plurality of industrial machines or robots. These machines may be operated or programmed by a human operator, remotely or in situ. They also frequently are checked or monitored in order to set up appropriate production sequences. Mobile or portable electronic control units may be used to assist in this.

The machines used in such production lines and systems may be arranged close to one another, or grouped together in cells. As individual machines, or groups of machines, may have different production tasks or programs, the functions and operations to be monitored generally will differ between machines or groups of machines. While monitors are known that are designed for use with particular machines or groups of machines, the great variety of machines to be monitored has prevented a single control unit from being used to monitor all of the machines in a particular production setting. This leads to increased production costs and inefficiencies. In addition, differences in the types of input and output from such control units inhibit the proper monitoring of the production process.

Monitoring systems and units are known in the art, but the use of such devices typically requires that on-site personnel possess a working knowledge of how to program such systems or units. Reprogramming would be needed, for example, when machines are replaced or modified, or new sensors or inputs are added. Reprogramming of this nature is expensive and time-consuming. Furthermore, such devices typically make only an initial check of make/break status when the machine is started, instead of checking that status every cycle.

Thus, what is needed is a mobile equipment process monitor able to be used with a variety of industrial machines, adapt its monitoring programs and systems based upon the different inputs from the various machines without reprogramming, continuously check a variety of inputs, and to provide appropriate warning signals and output to operators and monitoring programs.

### SUMMARY OF THE INVENTION

The present invention provides for a system and apparatus for continuously receiving and monitoring input from an industrial machine. A monitoring unit is removably attached to the machine, or plugged into a junction box attached to the machine. The monitoring unit continuously tests the validity of input data streams from a variety of sensors on the machine, and provides warnings through audible or visual signals, or by email. The monitoring unit can shut down machine operations if a variety of fault conditions are detected.

Monitoring units can be connected to a computer or network. A computer or network can handle input from multiple monitoring units on a plurality of machines. An operator or other personnel can send and receive information to and from the monitoring units so connected. Information from the monitoring units can be stored permanently in a database or similar data storage means, and used to produce a variety of useful reports and analyses.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### DESCRIPTION OF THE DRAWINGS

FIG. 1 is a schematic illustration of a equipment process monitoring system according to the present invention.

FIG. 2 is a block diagram of the monitoring capabilities of the equipment process monitor apparatus illustrated in FIG. 1.

### DETAILED DESCRIPTION OF THE INVENTION

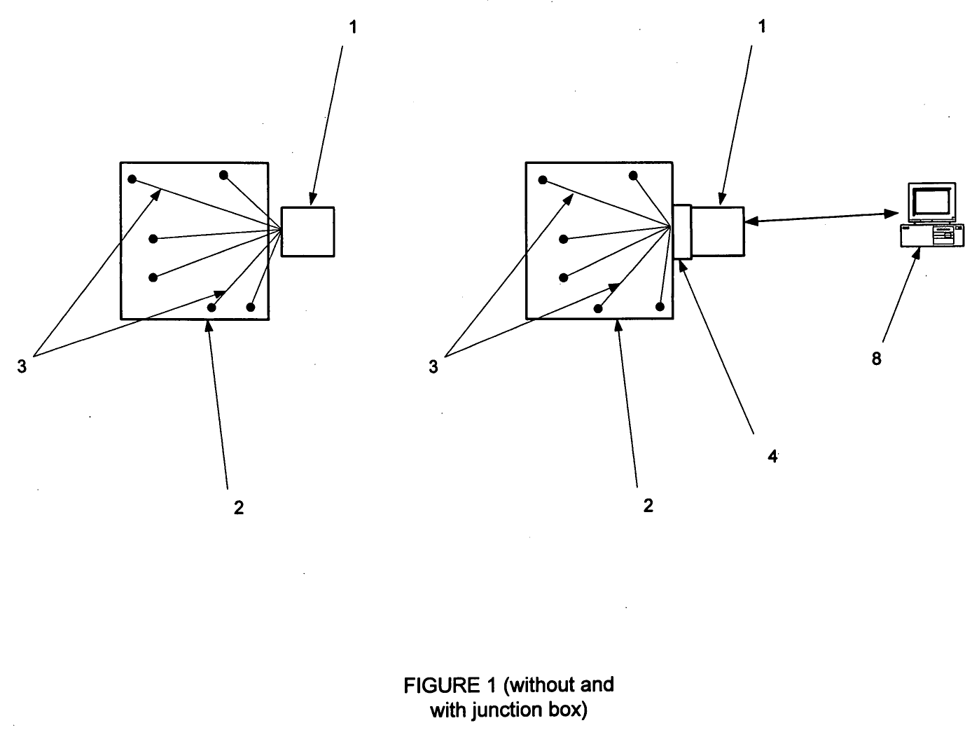

As illustrated in FIG. 1, an exemplary embodiment of the present invention provides for an equipment process monitoring system comprising a monitoring unit 1 connected to the machine 2 being monitored. The machine 2 has a number of sensor leads 3 that are connected to various parts of the machine 2 and provide data about the machine, or the item or product being handled by the machine.

The monitoring unit 1 may be directly connected to the sensor leads 3. In an alternative embodiment, a junction box 4 is mounted on the machine and directly connected to the sensor leads 3. The monitoring unit 1 can then be plugged into the junction box 4. This configuration has the advantage of the monitoring unit 1 being easily installed and removed on the machine 2.

When the monitoring unit 1 is plugged into the junction box 4 or is otherwise directly connected to the sensor leads 3, the monitoring unit 1 polls all of the potential inputs and connections, and identifies all live connections. This polling is repeated by the monitoring unit 1 every operating cycle. This enables the monitoring unit 1 to detect loose wires, modifications in inputs, and similar changes in the sensor leads and the machine.

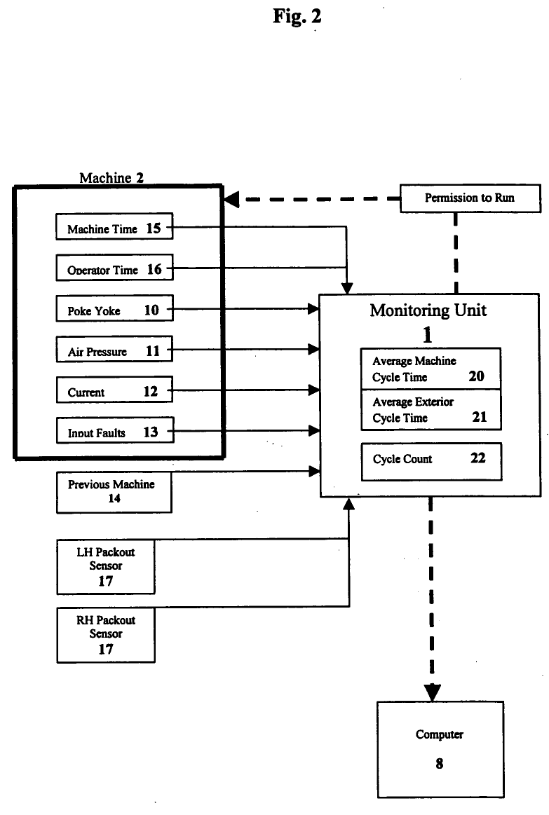

As shown in FIG. 2, the monitoring unit 1 receives information from a variety of inputs on a cyclical basis. These inputs include make/break indications on poke yoke sensors 10, main air pressure 11, current 12, general input faults 13, the running status of a previous machine or press 14, actual machine time 15, actual operator time 16, and right hand/left hand packouts 17. As it receives these inputs, the monitoring unit 1 stores the information cycle by cycle on a temporary basis. It uses these inputs in turn to calculate certain derived monitoring variables, such as an average machine cycle time 20, an average exterior cycle time 21, and a total part or cycle count 22.

The monitoring unit 1 controls operation of the machine based on these inputs and derived monitoring variables. Thus, for example, all connected poke yoke sensor leads 10 will have to make and break during each cycle in order for the next cycle to be enabled. This prevents the poke yoke sensors 10 from being fixed in an “on” or “make” position by a machine operator. Similarly, the machine will be disabled from continuing if the main air pressure 11 drops below a certain level. In one embodiment, for example, the machine will be disabled when the main air pressure 11 drops below 55 PSI.

The monitoring unit 1 also performs a continuity check to ensure that the current 12 remains on. If a break in the current 12 is detected, the machine is shut down. Similarly, any general input faults 13, indicating conditions such as a sonic overload or over-torquing, will cause the machine to be shut down as well. If a cycle is interrupted or a fault is detected, the monitoring unit 1 must be reset before the machine will be permitted to continue to the next cycle. Resetting may be accomplished by appropriate commands to the monitoring unit 1, such as pressing a reset button 7 on the monitoring unit 1.

Longer-term storage of data and information is accomplished by the transmission of data from the monitoring unit 1 to a computer 8 or machine containing a microprocessor and data storage means. The computer 8 may be part of a local area or wide area network. The computer 8 has the capability of receiving and recording all information sent from the monitoring unit 1 on a continuous, cycle-by-cycle basis. The computer 8 can store the data in a variety of forms, including a relational database. The information can then be analyzed and used to monitor machine operation and the process instantaneously or over time. Reports can be generated enabling operations staff and management to check production and operations in a variety of detail. Quality control personnel can also look at this data on a historical basis for various analyses.

A variety of means can be used to transmit the data from the monitoring unit 1 to the computer or similar machine. In one exemplary embodiment, the monitoring unit 1 has a single 10/100 Mbps Fast Ethernet port and RJ 45 socket, which may be readily connected to a network hub, switch, or router by suitable means, such as a standard CATS5 cable with a RJ45 plug. In another exemplary embodiment, the monitoring unit 1 communicates wirelessly with the computer 8 or network.

In yet another alternative embodiment, the computer 8 or network is further connected to the Internet or World Wide Web. The monitoring unit 1 can then be accessed from anywhere in the world using a suitable program, interface, or web browser. Access can be restricted by suitable security means, such as a passworded account system.

An important function of the monitoring unit is the ability to respond to a variety of problems, error signals, or fault conditions, such as numerous machine resets, lengthy down time, machine by-pass, continuity faults (e.g., heater burnout, blown fuses), general input faults, low air pressure, or poke yoke sensor malfunctions. Possible responses by the monitoring unit include shutting down the machine, producing an audible alarm or signal, producing a visual alarm or signal (e.g., a red light), or sending an email to monitoring or operations personnel.

A machine may have more than one monitoring unit at a time, depending on the number and type of data to be monitored, or the importance of having a duplicate failsafe monitoring system. A computer or network may have more than one monitoring unit with which it communicates, limited only by the capacity of the computer or network. In this manner, a group of machines in a production cell can be monitored from a single computer or network.

The present invention has utility beyond simple monitoring, as the information collected from the monitoring units can be used for production planning and similar purposes. In one illustrative embodiment, for example, personnel responsible for scheduling production runs can obtain the historical and current data for a particular production cell, and cause the system to evaluate, based on the actual production rate and history of that production cell, whether that production cell will be able to meet a particular production requirement or demand (i.e., a certain quantity of parts needed within a particular time period). If the production requirement is not feasible, the system will so inform the scheduler. If the production requirement is feasible, the system will continuously monitor the production of that production cell, and alert the scheduler in the event of any down time, work stoppage, or similar condition that would jeopardize meeting the production requirement.

The system also allows for monitoring by supervisors. Supervisors can input a quantity to be produced by each production cell for a particular run or batch of runs. When the quantity to be produced is reached the supervisor can be notified of that fact by the system by appropriate means, such as a indicator light, audible signal, email, or by a computer message. In the event of any down time, work stoppage, or similar problem, the supervisor will be notified of that as well.

The system will also improve quality control. Warnings can be sent to appropriate personnel, such as the quality control department, in the event conditions arise that indicate bad or malformed parts are potentially being produced. Such conditions could include sonic overloads, too many resets, heater burnout, and the like.

In order to prevent interference with the monitoring unit, the machine can be wired so that it will not run unless a monitoring unit is attached, or plugged into a junction box, and the operator enters the machine number. Alternatively, the machine number can be read by the monitoring unit automatically, either electronically or using infrared technology. In the event that a sensor malfunctions or a work stoppage occurs, and the continued operation of the machine is desired even without monitoring, a supervisor can request a by-pass plug from quality control or other appropriate supervisory personnel, which will allow the machine to run but will not monitor the sensors. This allows the production run to be completed, and alerts quality control or other supervisory personnel that close inspection of that particular run may be warranted. The by-pass plug distribution can also result in a maintenance work order for repair of the machine.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. An equipment process monitoring system, comprising:
a monitoring unit; and
a plurality of sensor leads, wherein the sensor leads are connected to one or more components of a machine or piece of equipment and provide input and connection data to the monitoring unit;
wherein the monitoring unit polls all of the sensor leads on a periodic basis to detect and identify all inputs and connections.

2. The system of claim 1, further comprising:
a. a junction box mounted on the machine or piece of equipment, wherein the junction box is connected to one or more of the sensor leads, and the monitoring unit is plugged into the junction box.

3. The system of claim 1, further wherein the input and connection data include one or more of make/break indications on poke yoke sensors, main air pressure, current, general input faults, the running status of a previous machine or piece of equipment, actual machine time, actual operator time, and right hand/left hand packouts.

4. The system of claim 1, further wherein the monitoring unit stores the input and connection data and calculates derived monitoring variables.

5. The system of claim 4, wherein the derived monitoring variables include one or more of average machine cycle time, average exterior cycle time, total part count, and cycle count.

6. The system of claim 1, further wherein the monitoring unit monitors the input and connection data and ceases operation of the machine or piece of equipment certain if particular input or connection data is of a certain value, exceeds a certain threshold, or is outside a certain parameter range.

7. The system of claim 6, further wherein the monitoring unit must be reset after ceasing operation of the machine or piece of equipment.

8. The system of claim 1, further wherein the monitoring unit perform a continuity check to ensure that current to the machine or piece of equipment remains on.

9. The system of claim 1, further comprising long term data storage means for receiving and storing data transmitted from the monitoring unit.

10. The system of claim 9, further wherein the long term data storage means is attached or connected to, or contained within, a computer or computer network in communication with the monitoring unit.

11. The system of claim 10, further wherein said communication is wireless.

12. The system of claim 10, further wherein said communication is through the Internet.

13. The system of claim 10, further wherein the monitoring unit can be accessed and controlled from a remote location.

14. The system of claim 1, further wherein the monitoring unit provides a alarm signal or message when it detects a certain condition or status in the machine or piece of equipment.

15. The system of claim 1, further comprising a second monitoring unit monitoring input and connection data from the machine or piece of equipment.

16. The system of claim 10, further wherein the computer or computer network is in communication with a plurality of monitoring units connected to a plurality of machines or pieces of equipment.

17. The system of claim 10, further wherein the data collected is used to prepare reports.

18. The system of claim 1, further wherein the machine or piece of equipment cannot run unless the monitoring unit is connected.

19. The system of claim 18, further wherein the monitoring unit reads the machine or equipment number automatically.
